(19) United States
(12) Patent Application Publication
(10) Pub. No.: US 2026/0362363 A1
(43) Pub. Date: Nov. 12, 2026

(54) MULTI-LINK OPERATION EXTENSIONS FOR INTEGRATED MILLIMETER WAVE

(71) Applicant: Cisco Technology, Inc., San Jose, CA (US)

(72) Inventors: Juan Carlos Zuniga, Montreal (CA); Brian D. Hart, Sunnyvale, CA (US); Malcolm Muir Smith, Richardson, TX (US); Matthew Aaron Silverman, Shaker Heights, OH (US); Alan W. Dumdei, Greenville, TX (US); Ardalan Alizadeh, Milpitas, CA (US); Peiman Amini, Fremont, CA (US)

(21) Appl. No.: 19/674,847

(22) Filed: May 12, 2026

Related U.S. Application Data
(60) Provisional application No. 63/804,418, filed on May 12, 2025.

(51) Int. Cl. H04W 60/04; H04L 5/00; H04W 8/22

(52) U.S. Cl. CPC H04W 60/04; H04L 5/0053; H04W 8/22

(57) ABSTRACT

Multi-Link Operation (MLO) extension for Integrated millimeter Wave (ImmW) operation may be provided. Supporting MLO in ImmW includes transmitting, by an access point (AP) multi-link device (MLD) via a sub-7GHz link, a multi-link (ML) element comprising capability information indicating support for an anchor relationship between a first affiliated AP of the AP MLD operating in a sub-7GHz band and a second affiliated AP of the AP MLD operating in an ImmW band. The AP MLD establishes, via the sub-7GHz link, an association with a non-AP MLD. The AP MLD establishes the anchor relationship by transmitting signaling to the non-AP MLD identifying the first affiliated AP as an anchor AP and the second affiliated AP as an anchor-dependent AP. The AP MLD manages, via the sub-7GHz link, one or more operations associated with an ImmW link on behalf of the non-AP MLD based on the anchor relationship.

### RELATED APPLICATION

Applicant claims the benefit of and priority to U.S. Provisional Application No. 63/804,418, filed May 12, 2025, the disclosure of which is incorporated herein by reference in its entirety.

### TECHNICAL FIELD

The present disclosure relates generally to providing Multi-Link Operation extension for Integrated millimeter Wave operation.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Multi-Link Operation (MLO) extension for Integrated millimeter Wave (ImmW) operation in accordance with aspects of the present disclosure.

FIG. 2 illustrates an example Reconfiguration Multi-Link (ML) Element in accordance with aspects of the present disclosure.

FIG. 3 illustrates an example MLD Capabilities and Operations subfield in accordance with aspects of the present disclosure.

FIG. 4 illustrates an example Extended MLD Capabilities and Operations subfield in accordance with aspects of the present disclosure.

FIG. 5 illustrates an example signaling process between an AP MLD and a non-AP MLD for supporting ImmW operation in accordance with aspects of the present disclosure.

FIG. 6 is a flow diagram illustrating a method for MLO is ImmW in accordance with aspects of the present disclosure.

FIG. 7 is a block diagram of a computing device in accordance with aspects of the present disclosure.

FIG. 8 is a block diagram of a communications device in accordance with aspects of the present disclosure.

### DETAILED DESCRIPTION

### Overview

Multi-Link Operation (MLO) extension for Integrated millimeter Wave (ImmW) operation may be provided. Supporting MLO in ImmW includes transmitting, by an access point (AP) multi-link device (MLD) via a sub-7GHz link, a multi-link (ML) element comprising capability information indicating support for an anchor relationship between a first affiliated AP of the AP MLD operating in a sub-7GHz band and a second affiliated AP of the AP MLD operating in an ImmW band. The AP MLD establishes, via the sub-7GHz link, an association with a non-AP MLD. The AP MLD then establishes the anchor relationship by transmitting signaling to the non-AP MLD identifying the first affiliated AP as an anchor AP and the second affiliated AP as an anchor-dependent AP. The AP MLD manages, via the sub-7GHz link, one or more operations associated with an ImmW link on behalf of the non-AP MLD based on the anchor relationship.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless Local Area Network (WLAN) standards, including IEEE 802.11be (also referred to as Extremely High Throughput (EHT) Wi-Fi), introduce mechanisms enabling devices to communicate across multiple frequency bands and/or channels simultaneously. One such mechanism is referred to as Multi-Link Operation (MLO).

MLO enables a wireless device to establish and utilize multiple communication links concurrently between affiliated stations associated with the same logical connection. A Multi-Link Device (MLD) may include multiple radios, interfaces, or communication entities configured to operate over different frequency bands, channels, channel widths, or radio access parameters. The multiple links are typically established using one or more sub-7GHz bands (e.g., 2.4GHz, 5GHz, 6GHz). By utilizing multiple links concurrently or selectively, MLO may improve aggregate throughput, reduce latency, increase robustness against interference or congestion, and provide enhanced quality of service for latency-sensitive or high-bandwidth applications.

An Access Point (AP) MLD communicates with a non-AP MLD using a plurality of affiliated links. Each affiliated link may correspond to a distinct physical layer (PHY) and/or medium access control (MAC) instance. Traffic may be distributed across the plurality of links according to various scheduling, load balancing, prioritization, power management, or channel condition criteria. In certain implementations, communication over multiple links may occur simultaneously, while in other implementations links may be dynamically enabled, disabled, prioritized, aggregated, or otherwise managed based on operating conditions.

The IEEE 802.11bq working group is developing standards for Integrated Millimeter Wave (ImmW) operation. ImmW uses high-frequency, unlicensed bands in the range of approximately 42GHz to 71GHz, including the 60GHz band. These high frequencies enable very fast data rates over short ranges, making ImmW well-suited for high-speed, short-range applications such as streaming video, wireless docking, virtual reality, and augmented reality. Prior millimeter wave (mmW) technologies, including IEEE 802.11ay, defined channels for their respective frequency bands; however, ImmW in IEEE 802.11bq introduces new channelization requirements that are not addressed by those prior definitions.

Unlike prior standalone wireless technologies, ImmW operation under 802.11bq is not intended to function independently. An ImmW device may not operate as a standalone 60GHz client connecting directly to a standalone 60GHz AP. Instead, ImmW operation can occur with a co-located sub-7GHz link operating within the same MLD. The sub-7GHz link may serve as an anchor for the ImmW link, providing the foundational infrastructure through which the ImmW link is discovered, configured, and managed. Specifically, a client discovers 60GHz ImmW capabilities through the sub-7GHz link and, after discovery, may begin exchanging traffic over the 60GHz ImmW link. After the ImmW link is established, management and control traffic may continue to flow through the sub-7GHz anchor link. The anchor sub-7GHz link may be responsible for functions including client association setup, beamforming training triggering, Target Wait Time (TWT) Service Period (SP) setup, Block Acknowledgment (BA) agreement establishment, and real-time BA reception.

This anchor-dependent relationship defines a new type of inter-link dependency within an MLD that did not previously exist in MLO frameworks. Existing MLO specifications, including the Multi-Link (ML) element, define band usage and link management for 2.4GHz, 5GHz, and 6GHz sub-7GHz bands, but do not define mechanisms to express that one link within an MLD is structurally dependent upon another link for management and control. Nor do existing specifications define new operating classes and channelization for the ImmW 60GHz band, preferred scanning channel (PSC) rules adapted for ImmW’s large number of potential channels, or frame-level signaling to add or remove anchor-link relationships dynamically.

The embodiments described herein address these gaps. In particular, the present disclosure describes enhancements to MLO to support ImmW operation, including: a new anchor-dependent link relationship within an MLD, wherein a sub-7GHz link acts as an anchor for one or more ImmW links; additions to the ML Element reconfiguration operation type subfield to signal the addition and deletion of anchor relationships; additions to MLD Capabilities and Operations elements and Extended MLD Capabilities to advertise and negotiate anchor-link support; additions to the Per-STA Info STA Control field to indicate the presence of an anchor-dependent station; new operating classes for ImmW 60GHz channelization, including 160MHz, 320MHz, 640MHz, and 1280MHz channel widths across the 57-71GHz range, for applicable regulatory domains (e.g., US, EU, Japan, China, and global tables); and PSC scanning rules and a PSC element in AP Capabilities adapted for ImmW to reduce the scanning burden imposed by the large number of available 60GHz channels.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

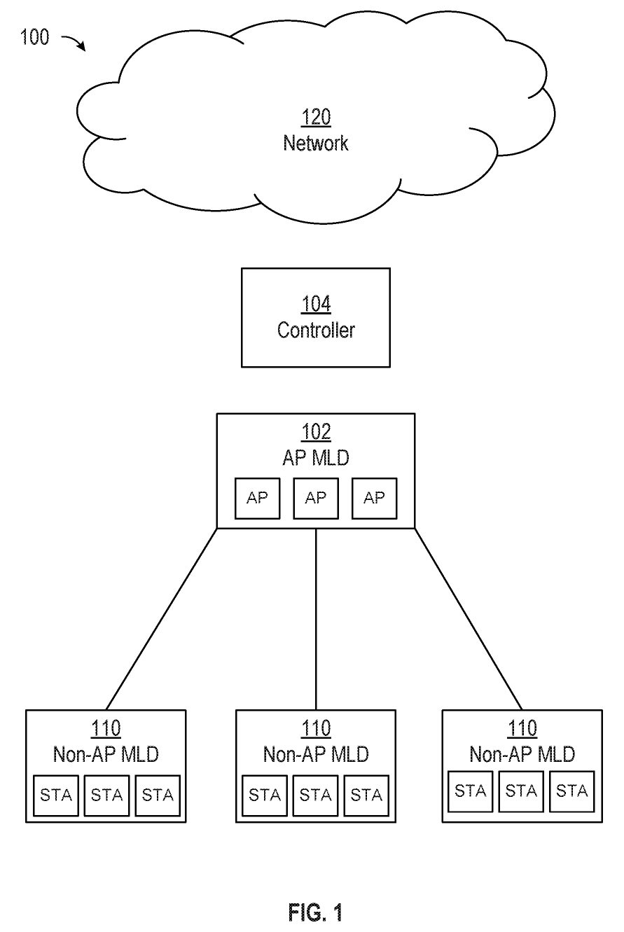

FIG. 1 is a block diagram of an operating environment 100 for MLO extensions for ImmW operation. The operating environment 100 includes an AP MLD 102, a controller 104, non-AP MLDs 110, and a network 120.

The AP MLD 102 is configured to communicate with and/or enable devices such as the non-AP MLDs 110 to wirelessly connect to the network 120. The controller 104 is a network controller, such as a Wireless Local Area Network (WLAN) controller, configured to manage and control the AP MLD 102, the non-AP MLDs 110, and/or other network devices to allow wireless devices to connect to and utilize the network 120. The AP MLD 102 and/or the controller 104 can include router components or connect to an external router for routing traffic and otherwise managing the operation of the WLAN. In certain embodiments, the AP MLD 102 acts as a controller and the controller 104 is not present in the operating environment 100.

The non-AP MLDs 110 are any client device, such as a smartphone, tablet, laptop, personal computer, or internet-of-things device. As shown in FIG. 1, the non-AP MLDs 110 and the AP MLD 102 are MLDs, each including one or more affiliated STAs (referred to as APs with respect to the AP MLD 102). The non-AP MLDs 110 use their affiliated STAs to form links with the affiliated APs of the AP MLD 102. Each affiliated STA/AP may include Physical (PHY)-layer and lower-Media Access Control (MAC) components. The MLDs may also include an upper-MAC for coordinating the multiple affiliated STAs/APs (or links) that are part of the MLD. The affiliated STAs/APs can use different frequency bands for various wireless links, including 2.4GHz, 5GHz, 6GHz, ImmW bands including 60GHz, or other bands.

The network 120 is a set of devices that facilitate communication between senders and destinations, such as by implementing communication protocols. Example networks 120 include local area networks, wide area networks, intranets, or the Internet.

As described above, an ImmW device may not operate independently as a standalone 60GHz client connecting to a standalone 60GHz AP. Instead, ImmW operation depends upon a co-located sub-7GHz link operating within the same MLD. Through the embodiments described herein, a new relationship between co-located APs within an MLD is defined, wherein one or more APs act as anchor APs and one or more other APs (e.g., ImmW APs) rely upon those anchor APs for one or more of the following functions: management and configuration operations, including setting up client association, triggering beamforming training, setting up TWT SPs, and establishing BA agreements; and real-time operations, including receiving BA traffic. In certain embodiments, a sub-7GHz AP within the MLD acts as an anchor for management and control traffic associated with one or more ImmW APs within the same MLD.

This anchor-dependent relationship defines a new type of inter-link dependency within an MLD. A non-AP MLD 110 discovers the ImmW 60GHz capability of the AP MLD 102 through the sub-7GHz link and, after discovery, may begin exchanging traffic over the 60GHz ImmW link. Even after the ImmW link is established, management and control traffic may continue to flow through the sub-7GHz anchor link. To support this relationship, additions and adjustments are made to how key elements are managed in MLO, including: new Reconfiguration Operation Type subfield values for adding and deleting anchor relationships; additions to MLD Capabilities and Operations and Extended MLD Capabilities elements to advertise anchor support; a new Anchor-Dependent STA present bit in the Per-STA Info STA Control field; a PSC element for ImmW 60GHz scanning; and new operating class definitions for ImmW channelization.

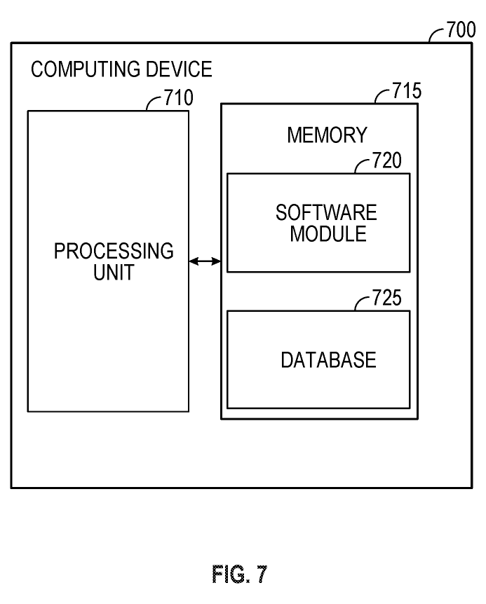

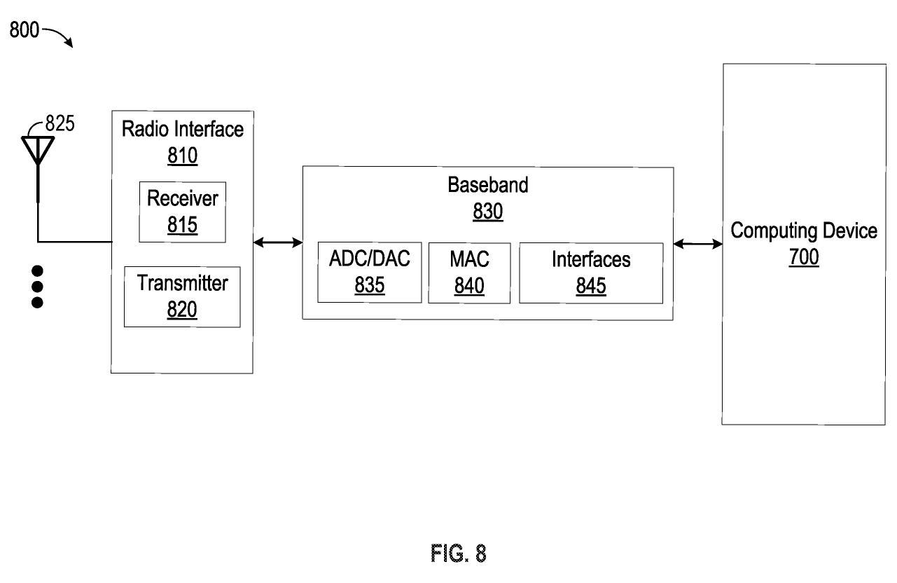

The elements described above of the operating environment 100 (e.g., the AP MLD 102, the controller 104, the non-AP MLDs 110, the devices of the network 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 7 and 8, the elements of the operating environment 100 may be practiced in a computing device 700 and/or communications device 800.

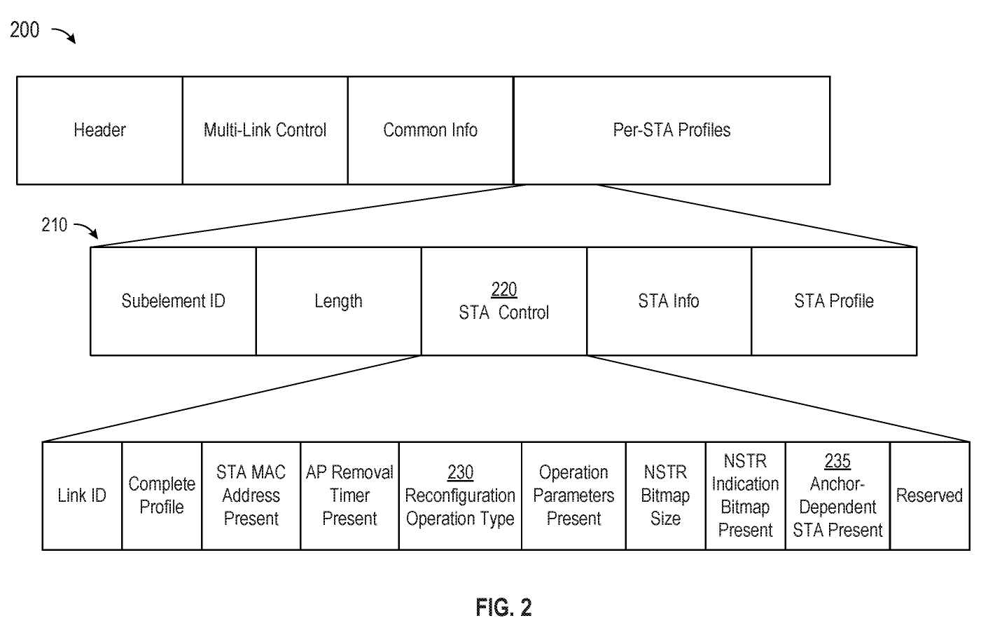

FIG. 2 illustrates an example Reconfiguration ML Element 200. In some embodiments, management signaling between MLDs may utilize the Reconfiguration ML Element 200 to announce an ML reconfiguration operation by the AP MLD, to initiate an ML reconfiguration operation for adding or deleting links to an existing ML setup by the non-AP MLD, or to provide a reconfiguration recommendation by the AP MLD to its associated non-AP MLD(s). The Reconfiguration ML Element 200 may be carried in any applicable management frame, including a link reconfiguration frame or UHR link reconfiguration frame (e.g., request, response, or notify variants).

The Reconfiguration ML element 200 may include a Multi-Link Control field, a Common Info field, and one or more Per-STA Profile subelements 210. The Multi-Link Control field may indicate that the element is a Reconfiguration ML element and may identify the type or format of information carried therein. The Common Info field may include information applicable to the MLD as a whole, such as an MLD MAC Address, Link ID information, reconfiguration control information, presence bitmap information, and/or other common parameters. Each Per-STA Profile subelement 210 may correspond to an affiliated station or link and may include a STA Control field 220, a Link ID field, and additional per-link or per-STA information, such as capability information, operational parameters, status information, and/or embedded information elements associated with the corresponding affiliated station. The Reconfiguration ML element 200 may therefore convey updated multi-link configuration information associated with operations such as adding, deleting, modifying, or otherwise reconfiguring one or more links of an existing multi-link association.

The Reconfiguration Operation Type subfield 230 of a respective Per-STA Profile subelement 210 is set to indicate the type of MLO update for the link identified by the Link ID subfield of the Reconfiguration ML Element 200. To enable MLO in ImmW, new values of the Reconfiguration Operation Type subfield 230 are defined for indicating the addition or deletion of anchor relationships and links that are being aided by anchor links. In one embodiment, one of the reserved values (e.g., from the values reserved in the existing subfield encoding) is assigned to indicate the addition of an anchor, and another of the reserved values is assigned to indicate the deletion of an anchor. While the Reconfiguration Operation Type subfield 230 of the Per-STA Profile subelement 210 represents one embodiment for carrying add/delete anchor semantics, these semantics may alternatively be expressed in any field, subfield, subelement, or element at any level of the frame hierarchy, and may appear in any applicable management frame, including, but not limited to, link reconfiguration request, response, or notify frames, and UHR link reconfiguration frames.

The STA Control field 220 further includes an Anchor-Dependent STA present bit 235, defined from one of the existing reserved bits. The Anchor-Dependent STA present bit 235 is set to a first value (e.g., 1) to indicate the presence of an anchor-dependent STA and a second value (e.g., 0) to indicate that no anchor-dependent STA is present. The Link ID subfield and the Reconfiguration Operation Type subfield 230 of the Per-STA Profile subelement 210 are used together to add and delete anchor relationships.

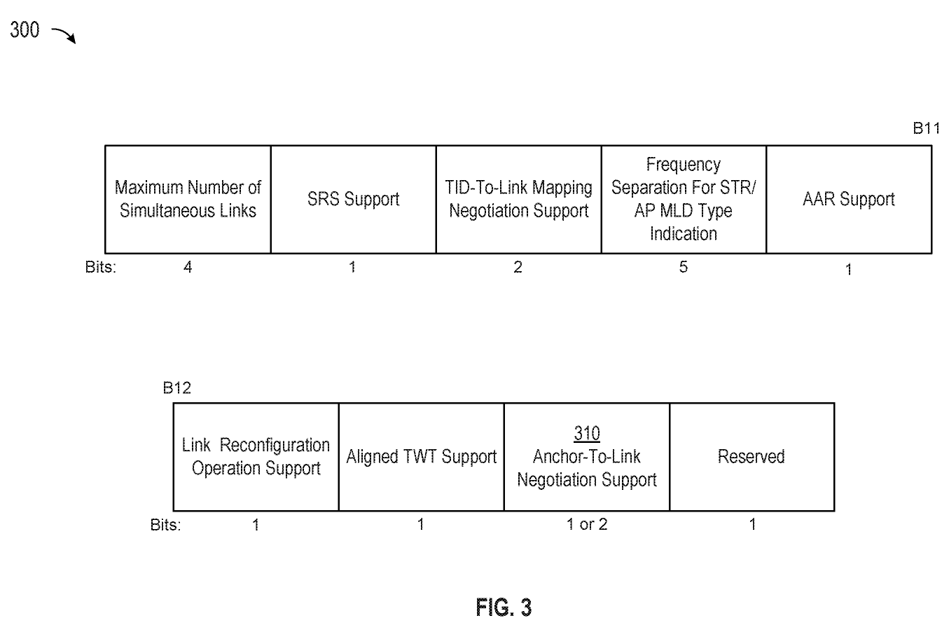

FIG. 3 illustrates an example MLD Capabilities and Operations subfield 300. The MLD Capabilities and Operations subfield 300 is located within the Common Info field of a Multi-Link element, including for example the Reconfiguration ML element 200. The presence of the MLD Capabilities and Operations subfield 300 is controlled through the presence bitmap or control information associated with the Common Info field. The subfield carries MLD-level operational and capability information applicable across the ML device as a whole, rather than link-specific information associated with an individual Per-STA Profile.

To enable MLO in ImmW, the MLD Capabilities and Operations subfield 300 includes an Anchor-to-Link Negotiation Support field 310. The Anchor-to-Link Negotiation Support field 310 indicates whether an anchor-to-link mapping can be established and indicates whether an anchor-to-link element is present for conveying which links are anchored by which other links. In general, any AP within an MLD may be identified as an anchor for any other AP within the same MLD, such that the anchor relationship is not restricted to ImmW operation.

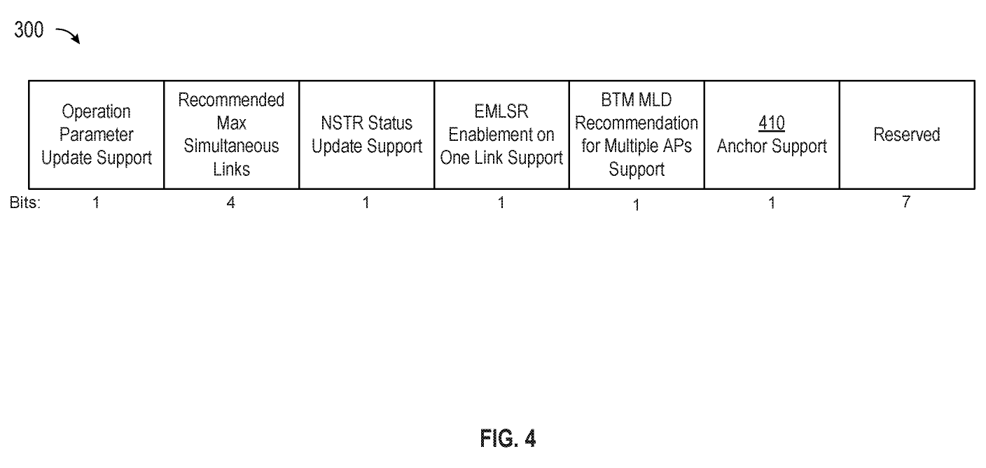

The Anchor-to-Link Negotiation Support field 310 may be one or two bits in length. When one bit, a first value indicates anchor support is disabled and a second value indicates anchor support is enabled. When two bits, a first value indicates anchor support is disabled, a second value indicates anchor support is enabled and all sub-7GHz APs may act as anchors, a third value indicates anchor support is enabled and certain APs may act as anchors while others cannot (e.g., as identified by an anchor-to-link element), and a fourth value is reserved for future use. While the Anchor-to-Link Negotiation Support field 310 is shown between the Aligned TWT Support field and a reserved bit in the illustrated embodiment, it may be positioned anywhere within the MLD Capabilities and Operations subfield 300, and the reserved bit may not be present if the field is assigned to that bit position. In further embodiments, the Anchor-to-Link Negotiation Support field 310 may alternatively be located within the Extended MLD Capabilities and Operations subfield 400 described with respect to FIG. 4.

FIG. 4 illustrates an example Extended MLD Capabilities and Operations subfield 400. The Extended MLD Capabilities and Operations subfield 400 is located within the Common Info field of an ML element, including for example the Reconfiguration ML element 200. The Extended MLD Capabilities and Operations subfield 400 supplements the base MLD Capabilities and Operations subfield 300 with additional MLD-level capability and operational information. Like the MLD Capabilities and Operations subfield 300, the Extended MLD Capabilities and Operations subfield 400 applies at the MLD level rather than to an individual affiliated link or STA Profile. Its presence is indicated by the Common Info presence bitmap or control information.

To enable MLO in ImmW, a reserved bit within the Extended MLD Capabilities and Operations subfield 400 is defined as an Anchor Support bit 410. The Anchor Support bit 410 is set to a first value (e.g., 1) to indicate that the MLD supports anchoring between one or more STAs that can act as an anchor (e.g., sub-7GHz STAs) and one or more STAs that can be anchored (e.g., ImmW STAs), and a second value (e.g., 0) to indicate that anchoring is not supported.

In the 6GHz band, PSCs are a subset of channels on which APs are expected to preferentially transmit discovery frames, such as Beacon frames, Probe Response frames, FILS Discovery frames, and Unsolicited Broadcast Probe Responses. A STA scanning the 6GHz band may therefore initially scan only the PSC channels rather than scanning every possible 20MHz channel. For the 6GHz band, PSC channels are spaced every 80 MHz and correspond to specific 20MHz primary channels. PSC information is generally conveyed through an AP’s selected primary channel configuration, Reduced Neighbor Report (RNR) information, and 6GHz discovery rules.

PSC operation is extended for use in ImmW bands (e.g., 60GHz). Because the 57-71GHz range spans approximately 14GHz of spectrum, which, divided into 160MHz channels, yields nearly 87 channels, non-AP MLDs would need to scan a large number of channels without PSC. In some embodiments, scanning at 60GHz may be avoided entirely, with the sub-7GHz anchor link directing the non-AP MLD 110 to the appropriate 60GHz channel and PSC channels. In embodiments where PSC channels are defined for ImmW, they may be spaced at every N×160MHz, reducing the number of channels to scan.

A PSC element is carried in the AP Capabilities information of an ML element. For example, the PSC element may be included in an AP Capabilities field of a Per-STA Profile subelement of a Common Info field of an ML element. The PSC element may be set to indicate ImmW support for PSC-based scanning, allowing a scanning STA to identify and prioritize PSC channels in the ImmW band.

IEEE 802.11 defines operating classes that specify a set of permitted operating parameters for a given geographic regulatory domain. These operating classes are defined in Annex E of the IEEE 802.11 standard, with separate tables for different regulatory jurisdictions: Table E-1 (United States), Table E-2 (Europe), Table E-3 (Japan), Table E-4 (Global), and Table E-6 (China). Each operating class specifies the frequency band, channel numbering, channel spacing, permitted channel set, channel center frequency segment indices, and applicable behavioral or regulatory constraints (the “Behavior Limits Set”). Behavioral constraints may include requirements such as Dynamic Frequency Selection (DFS), Transmit Power Control (TPC), indoor-only operation, passive scanning, or transmit power limits. The channel starting frequency and channel spacing together define how channel numbers map to actual RF center frequencies, and for wider bandwidths the tables may additionally define channel center frequency segment indices and bonded-channel structures.

Prior IEEE 802.11ay technology defined operating classes for its respective millimeter wave channels in Tables E-1 through E-4 and E-6; however, ImmW 802.11bq introduces new bandwidths and center frequencies that are not addressed by those prior operating class definitions. To support ImmW operation, new operating classes are defined in each of the applicable Annex E tables using available reserved operating class numbers. The new operating class values are selected from the reserved ranges in each table: values 131–255 in Table E-1 (US); values 131–255 in Table E-2 (EU); values 131–255 in Table E-3 (JP); available reserved identifiers in Table E-4 (Global); and values 131–255 in Table E-6 (China). The new operating classes begin at the 56.16GHz starting frequency used by 802.11ay in Tables E-1 through E-3 and define channel sets and numerology for the 57-71GHz range across four channel widths: 160MHz (87 channels), 320MHz (43 channels), 640MHz (21 channels), and 1280MHz (10 channels).

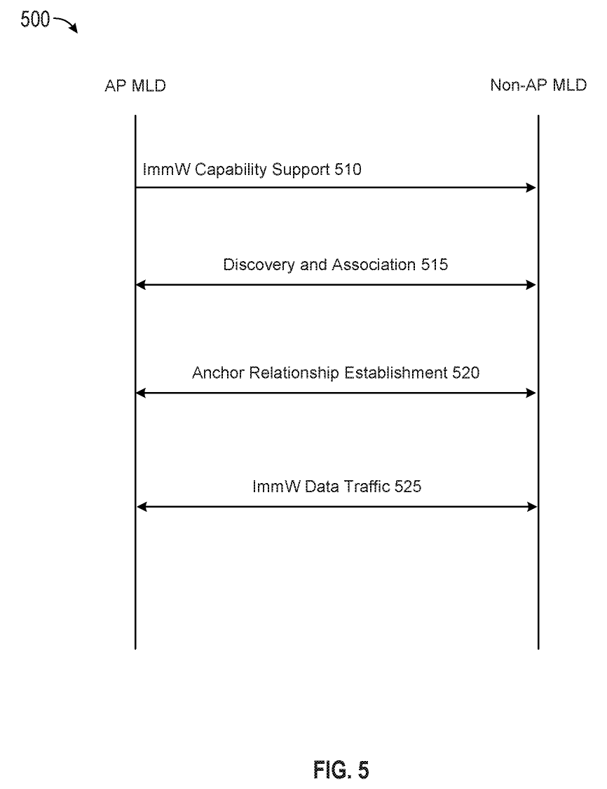

FIG. 5 illustrates an example signaling process 500 between an AP MLD and a non-AP MLD for supporting ImmW operation. The signaling process 500 is described with reference to the elements and fields discussed with respect to FIGS. 1–4. The operations of the signaling process 500 are illustrative and are not limited to the specific sequence, frame types, or message exchanges shown. Various implementations may employ different frame structures, orderings, or triggering conditions while remaining consistent with the embodiments described herein.

At operation 510, the AP MLD signals ImmW capability support to the non-AP MLD. The AP MLD may advertise ImmW anchor support through management frames such as Beacon frames or Probe Response frames. This advertisement may be carried within the Multi-Link element’s Common Info field and may include the MLD Capabilities and Operations subfield 300, the Extended MLD Capabilities and Operations subfield 400, or both. Through these fields, the AP MLD may convey whether anchor-to-link negotiation is supported, the scope of which affiliated APs may act as anchors, and whether an anchor-to-link mapping element is present. The AP MLD may additionally include a PSC element in its AP Capabilities information to indicate supported ImmW 60GHz preferred scanning channels, enabling the non-AP MLD to identify the relevant 60GHz channel in advance of association.

At operation 515, the non-AP MLD performs discovery and association with the AP MLD over the sub-7GHz anchor link. Because ImmW operation is not standalone, the non-AP MLD does not associate independently over the 60GHz ImmW link. Instead, discovery of the AP MLD’s ImmW capabilities and the initial association setup occur through the sub-7GHz link, which serves as the anchor for subsequent ImmW operation. The specific frames and procedures used for discovery and association may follow applicable MLO association procedures, and the non-AP MLD may use PSC information received during operation 510 to identify the ImmW channel to be used after association is complete.

At operation 520, the AP MLD and the non-AP MLD establish the anchor relationship between the sub-7GHz link and the ImmW link. This may be performed using the Reconfiguration ML element 200, carried in applicable reconfiguration or management frames, such as link reconfiguration request, response, or notify frames. The Reconfiguration Operation Type subfield 230 of the Per-STA Profile subelement 210 is set to a value indicating the addition of an anchor relationship, and the Anchor-Dependent STA present bit 235 of the STA Control field 220 identifies the ImmW STA as anchor-dependent. With the anchor relationship established, the sub-7GHz anchor link may manage and configure the ImmW link on behalf of the non-AP MLD, including triggering beamforming training, setting up TWT Service Periods, and establishing BA agreements. Management and control traffic associated with the ImmW link may continue to flow through the sub-7GHz anchor link throughout the duration of the anchor relationship. When the anchor relationship is no longer needed, a reconfiguration frame carrying a Reconfiguration Operation Type subfield value indicating deletion of an anchor may be exchanged to remove the anchor relationship.

At operation 525, data traffic flows between the AP MLD and the non-AP MLD over the 60GHz ImmW link, using the channelization defined by the new ImmW operating classes described herein. BA traffic associated with the ImmW data exchange may be received through the sub-7GHz anchor link. The ImmW link and the sub-7GHz anchor link may operate concurrently, with the sub-7GHz link continuing to carry management and control traffic while the ImmW link carries high-throughput data traffic.

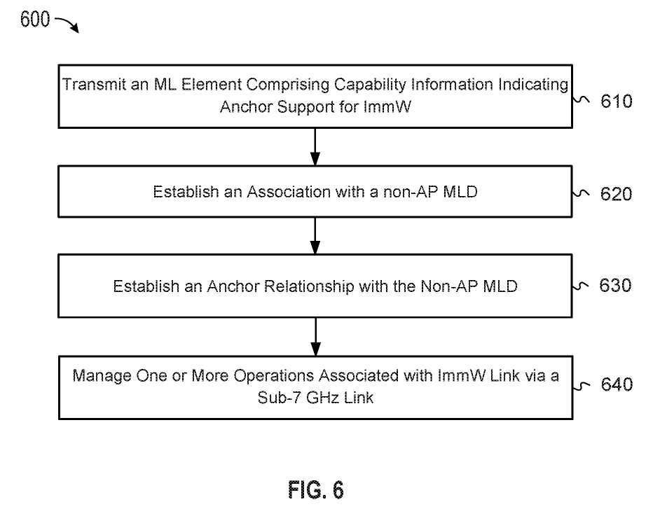

FIG. 6 illustrates a method 600 performed by an AP MLD for supporting ImmW operation using an anchor relationship. The operations of the method 600 are illustrated as discrete stages for clarity, but are not limited to the specific sequence shown, and various implementations may employ different orderings or additional intermediate operations.

At stage 610, the AP MLD transmits, via a sub-7GHz link, a ML element comprising capability information indicating support for an anchor relationship between a first affiliated AP of the AP MLD operating in a sub-7GHz band and a second affiliated AP of the AP MLD operating in an ImmW band. In one embodiment, the capability information comprises an anchor-to-link negotiation support field within an MLD Capabilities and Operations subfield of the ML element. The anchor-to-link negotiation support field may be a single bit indicating anchor support as enabled or disabled, or two bits indicating one of: a first value indicating anchor support is disabled, a second value indicating anchor support is enabled and all sub-7GHz APs may act as anchors, or a third value indicating anchor support is enabled and a subset of APs may act as anchors. In another embodiment, the capability information comprises an anchor support bit within an Extended MLD Capabilities and Operations subfield of the ML element, wherein the anchor support bit is set to a first value indicating that the AP MLD supports anchoring between one or more sub-7GHz APs acting as anchors and one or more ImmW APs acting as anchor-dependent APs. In some embodiments, the AP MLD includes both the anchor-to-link negotiation support field and the anchor support bit in the capability information. In further embodiments, the ML element transmitted at stage 610 additionally includes a PSC element within AP Capabilities information indicating one or more preferred scanning channels for the ImmW band, wherein the preferred scanning channels are spaced at intervals of N×160MHz within the ImmW band, allowing a scanning non-AP MLD to identify and prioritize ImmW channels without scanning all available channels.

At stage 620, the AP MLD establishes, via the sub-7GHz link, an association with the non-AP MLD. Because ImmW operation is not standalone, the initial association is established through the sub-7GHz link rather than the ImmW link directly.

At stage 630, the AP MLD establishes the anchor relationship by transmitting signaling to the non-AP MLD identifying the first affiliated AP as an anchor AP and the second affiliated AP as an anchor-dependent AP. In one embodiment, transmitting the signaling comprises transmitting a reconfiguration frame comprising a ML element that includes a Per-STA Profile subelement identifying the first affiliated AP as the anchor AP and the second affiliated AP as the anchor-dependent AP, wherein a reconfiguration operation type subfield of the Per-STA Profile subelement is set to a value indicating addition of the anchor relationship. The reconfiguration frame may be one of a link reconfiguration request frame, a link reconfiguration response frame, a link reconfiguration notify frame, a UHR link reconfiguration request frame, a UHR link reconfiguration response frame, or a UHR link reconfiguration notify frame. In general, the signaling identifying the anchor AP and anchor-dependent AP may be expressed in any field, subfield, subelement, or element at any level of a hierarchy within any applicable management frame. In some embodiments, the Per-STA Profile subelement further comprises an anchor-dependent STA present bit of a STA Control field set to a first value indicating that an anchor-dependent STA is present. In further embodiments, the AP MLD transmits a second reconfiguration frame comprising the reconfiguration operation type subfield set to a second reserved value indicating deletion of the anchor relationship when the anchor relationship is no longer needed.

At stage 640, the AP MLD manages, via the sub-7GHz link, one or more operations associated with an ImmW link on behalf of the non-AP MLD based on the anchor relationship. In one embodiment, managing the one or more operations comprises at least one of: setting up client association, triggering beamforming training, setting up a TWT SP, establishing a BA agreement, or receiving BA traffic associated with the ImmW link. In some embodiments, data traffic associated with the ImmW link flows over the ImmW link concurrently with management and control traffic flowing through the sub-7GHz anchor link. In further embodiments, the ImmW link operates using a channel defined by a new operating class for ImmW operation, wherein the new operating class defines channelization in the 57-71GHz frequency range for a geographic regulatory domain across one or more of: 160MHz channels, 320MHz channels, 640MHz channels, or 1280MHz channels, and wherein the new operating class is defined in one or more of Table E-1 for the United States, Table E-2 for Europe, Table E-3 for Japan, Table E-4 for global use, or Table E-6 for China, using a reserved operating class identifier value within the respective table and a channel starting frequency corresponding to 56.16GHz.

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for providing MLO in ImmW. Computing device 700, for example, may provide an operating environment for the AP MLD 102, the controller 104, the non-AP MLDs 110, the devices of the network 120, and the like. The AP MLD 102, the controller 104, the non-AP MLDs 110, the devices of the network 120, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 700 on the single integrated circuit (chip).

FIG. 8 illustrates an implementation of a communications device 800 that may implement one or more of the AP MLD 102, the controller 104, the non-AP MLDs 110, the devices of the network 120, etc. In various implementations, the communications device 800 may comprise a logic circuit. The logic circuit may include physical circuits to perform operations described for one or more of the AP MLD 102, the controller 104, the non-AP MLDs 110, the devices of the network 120, etc., for example. As shown in FIG. 8, the communications device 800 may include one or more of, but is not limited to, a radio interface 810, baseband circuitry 830, and/or the computing device 700.

The communications device 800 may implement some or all of the structures and/or operations for the AP MLD 102, the controller 104, the non-AP MLDs 110, the devices of the network 120, etc., storage medium, and logic circuit in a single computing entity, such as entirely within a single device. Alternatively, the communications device 800 may distribute portions of the structure and/or operations using a distributed system architecture, such as a client station server architecture, a peer-to-peer architecture, a master-slave architecture, etc.

A radio interface 810, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 810 may include, for example, a receiver 815 and/or a transmitter 820. The radio interface 810 may include bias controls, a crystal oscillator, and/or one or more antennas 825. In additional or alternative configurations, the radio interface 810 may use oscillators and/or one or more filters, as desired.

The baseband circuitry 830 may communicate with the radio interface 810 to process, receive, and/or transmit signals and may include, for example, an Analog-To-Digital Converter (ADC) for down converting received signals with a Digital-To-Analog Converter (DAC) 835 for up converting signals for transmission. Further, the baseband circuitry 830 may include a baseband or PHY layer processing circuit for the PHY link layer processing of respective receive/transmit signals. Baseband circuitry 830 may include, for example, a MAC processing circuit 840 for MAC/data link layer processing. Baseband circuitry 830 may include a memory controller for communicating with MAC processing circuit 840 and/or a computing device 700, for example, via one or more interfaces 845.

In some configurations, PHY processing circuit may include a frame construction and/or detection module, in combination with additional circuitry such as a buffer memory, to construct and/or deconstruct communication frames. Alternatively or in addition, MAC processing circuit 840 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
transmitting, by an access point (AP) multi-link device (MLD) via a sub-7GHz link, a multi-link (ML) element comprising capability information indicating support for an anchor relationship between a first affiliated AP of the AP MLD operating in a sub-7GHz band and a second affiliated AP of the AP MLD operating in an integrated millimeter wave (ImmW) band;
establishing, via the sub-7GHz link, an association with a non-AP MLD;
establishing the anchor relationship by transmitting signaling to the non-AP MLD identifying the first affiliated AP as an anchor AP and the second affiliated AP as an anchor-dependent AP; and
managing, via the sub-7GHz link, one or more operations associated with an ImmW link on behalf of the non-AP MLD based on the anchor relationship.

2. The method of claim 1, wherein transmitting the signaling comprises transmitting a reconfiguration frame comprising a ML element that includes a per-station (STA) profile subelement identifying the first affiliated AP as the anchor AP and the second affiliated AP as the anchor-dependent AP, wherein a reconfiguration operation type subfield of the per-STA profile subelement is set to a value indicating addition of the anchor relationship.

3. The method of claim 2, further comprising transmitting a second reconfiguration frame comprising the reconfiguration operation type subfield set to a second reserved value indicating deletion of the anchor relationship.

4. The method of claim 2, wherein the per-STA profile subelement further comprises an anchor-dependent STA present bit of a STA Control field set to a first value indicating that an anchor-dependent STA is present.

5. The method of claim 1, wherein managing the one or more operations comprises at least one of: setting up client association, triggering beamforming training, setting up a target wait time service period, establishing a block acknowledgement (BA) agreement, or receiving BA traffic associated with the ImmW link.

6. The method of claim 1, wherein the capability information comprises an anchor-to-link negotiation support field within an MLD capabilities and operations subfield of the ML element, wherein the anchor-to-link negotiation support field is one of: a single bit indicating anchor support as enabled or disabled; or two bits indicating one of a first value indicating anchor support is disabled, a second value indicating anchor support is enabled and all sub-7GHz APs may act as anchors, or a third value indicating anchor support is enabled and a subset APs may act as anchors.

7. The method of claim 1, wherein the capability information further comprises an anchor support bit within an extended MLD capabilities and operations subfield of the ML element, wherein the anchor support bit is set to a first value indicating that the AP MLD supports anchoring between one or more sub-7GHz APs acting as anchors and one or more ImmW APs acting as anchor-dependent APs.

8. A system comprising:
a memory storage; and
a processing unit coupled to the memory storage, wherein the processing unit is operative to:
transmit, via a sub-7GHz link, a multi-link (ML) element comprising capability information indicating support for an anchor relationship between a first affiliated AP of an access point (AP) MLD operating in a sub-7GHz band and a second affiliated AP of the AP MLD operating in an integrated millimeter wave (ImmW) band;
establish, via the sub-7GHz link, an association with a non-AP MLD;
establish the anchor relationship by transmitting signaling to the non-AP MLD identifying the first affiliated AP as an anchor AP and the second affiliated AP as an anchor-dependent AP; and
manage, via the sub-7GHz link, one or more operations associated with an ImmW link on behalf of the non-AP MLD based on the anchor relationship.

9. The system of claim 8, wherein to transmit the signaling comprises to transmit a reconfiguration frame comprising a ML element that includes a per-station (STA) profile subelement identifying the first affiliated AP as the anchor AP and the second affiliated AP as the anchor-dependent AP, wherein a reconfiguration operation type subfield of the per-STA profile subelement is set to a value indicating addition of the anchor relationship.

10. The system of claim 9, wherein the processing unit is further operative to:
transmit a second reconfiguration frame comprising the reconfiguration operation type subfield set to a second reserved value indicating deletion of the anchor relationship.

11. The system of claim 9, wherein the per-STA profile subelement further comprises an anchor-dependent STA present bit of a STA Control field set to a first value indicating that an anchor-dependent STA is present.

12. The system of claim 8, wherein to manage the one or more operations comprises at least one of: setting up client association, triggering beamforming training, setting up a target wait time service period, establishing a block acknowledgement (BA) agreement, or receiving BA traffic associated with the ImmW link.

13. The system of claim 8, wherein the capability information comprises an anchor-to-link negotiation support field within an MLD capabilities and operations subfield of the ML element, wherein the anchor-to-link negotiation support field is one of: a single bit indicating anchor support as enabled or disabled; or two bits indicating one of a first value indicating anchor support is disabled, a second value indicating anchor support is enabled and all sub-7GHz APs may act as anchors, or a third value indicating anchor support is enabled and a subset APs may act as anchors.

14. The system of claim 8, wherein the capability information further comprises an anchor support bit within an extended MLD capabilities and operations subfield of the ML element, wherein the anchor support bit is set to a first value indicating that the AP MLD supports anchoring between one or more sub-7GHz APs acting as anchors and one or more ImmW APs acting as anchor-dependent APs.

15. A non-transitory computer-readable medium that stores a set of instructions which when executed by a processing unit, cause the processing unit to perform a method comprising:
transmitting, via a sub-7GHz link, a multi-link (ML) element comprising capability information indicating support for an anchor relationship between a first affiliated AP of an access point (AP) multi-link device (MLD) operating in a sub-7GHz band and a second affiliated AP of the AP MLD operating in an integrated millimeter wave (ImmW) band;
establishing, via the sub-7GHz link, an association with a non-AP MLD;
establishing the anchor relationship by transmitting signaling to the non-AP MLD identifying the first affiliated AP as an anchor AP and the second affiliated AP as an anchor-dependent AP; and
managing, via the sub-7GHz link, one or more operations associated with an ImmW link on behalf of the non-AP MLD based on the anchor relationship.

16. The non-transitory computer-readable medium of claim 15, wherein transmitting the signaling comprises transmitting a reconfiguration frame comprising a ML element that includes a per-station (STA) profile subelement identifying the first affiliated AP as the anchor AP and the second affiliated AP as the anchor-dependent AP, wherein a reconfiguration operation type subfield of the per-STA profile subelement is set to a value indicating addition of the anchor relationship.

17. The non-transitory computer-readable medium of claim 16, the method executed by the set of instructions further comprising:
transmitting a second reconfiguration frame comprising the reconfiguration operation type subfield.

18. The non-transitory computer-readable medium of claim 16, wherein the per-STA profile subelement further comprises an anchor-dependent STA present bit of a STA Control field set to a first value indicating that an anchor-dependent STA is present.

19. The non-transitory computer-readable medium of claim 15, wherein managing the one or more operations comprises at least one of: setting up client association, triggering beamforming training, setting up a target wait time service period, establishing a block acknowledgement (BA) agreement, or receiving BA traffic associated with the ImmW link.

20. The non-transitory computer-readable medium of claim 15, wherein the capability information comprises an anchor-to-link negotiation support field within an MLD capabilities and operations subfield of the ML element, wherein the anchor-to-link negotiation support field is one of: a single bit indicating anchor support as enabled or disabled; or two bits indicating one of a first value indicating anchor support is disabled, a second value indicating anchor support is enabled and all sub-7GHz APs may act as anchors, or a third value indicating anchor support is enabled and a subset APs may act as anchors.
